(19) United States
(12) Patent Application Publication
(10) Pub. No.: US 2026/0332375 A1
(43) Pub. Date: Oct. 22, 2026

(54) METHODS AND SYSTEMS FOR SELF-INTERFERENCE CANCELLATION IN FULL-DUPLEX COMMUNICATION

(71) Applicant: Samsung Electronics Co., Ltd., Gyeonggi-do (KR)

(72) Inventors: Mouna HAJIR, San Diego, CA (US); Mojtaba RAHMATI, San Diego, CA (US); Hyuk Joon KWON, San Diego, CA (US); Dongwoon BAI, San Diego, CA (US)

(21) Appl. No.: 19/369,686

(22) Filed: Oct. 27, 2025

Related U.S. Application Data
(60) Provisional application No. 63/789,586, filed on Apr. 16, 2025.

(51) Int. Cl. H04L 5/14; H04B 7/06

(52) U.S. Cl. CPC H04L 5/1461; H04B 7/0634

(57) ABSTRACT

A method of self-interference cancellation in a full duplex communication system is provided. The method includes: generating a kernel matrix comprising basis functions representative of self-interference produced by a transmit signal of the full duplex communication system; performing principal component regression (PCR) based on the kernel matrix for self-interference estimation; selecting a subset of principal components based on a metric related to a reconstruction error of a received signal; estimating a coefficient vector using the subset of principal components to generate an estimate of the self-interference; and cancelling the self-interference from the received signal based on the self-interference estimate.

### CROSS-REFERENCE TO RELATED APPLICATION

This application claims the priority benefit under 35 U.S.C. § 119(e) of U.S. Provisional Application No. 63/789,586, filed on Apr. 16, 2025, the disclosure of which is incorporated by reference in its entirety as if fully set forth herein.

### TECHNICAL FIELD

The disclosure generally relates to full-duplex wireless communication systems. More particularly, the subject matter disclosed herein relates to improvements to self-interference cancellation using principal component regression (PCR) techniques.

### SUMMARY

Full-duplex wireless communication systems may transmit and receive simultaneously on the same frequency band, which can increase spectral efficiency. An obstacle to deployment of such systems is self-interference, which may be caused when a strong transmit signal leaks into the receiver chain and distorts a weaker desired signal.

To solve this problem, prior techniques have modeled self-interference using large sets of basis functions and applied adaptive filtering or PCR to estimate coefficients for reconstructing and subtracting interference from the received signal.

One issue with the above approach is that using large sets of basis functions creates high computational complexity and leads to numerical instability when many of the functions are correlated. These effects may reduce cancellation accuracy and limit system performance.

To overcome these types of issues, methods and systems are described herein for enhanced PCR.

In one approach, principal components may be selected based on a reconstruction error of a received signal.

In another, components may be selected using a metric derived from eigenvalues, the metric reflecting an error in coefficient estimation.

In a further approach, a kernel matrix may be scaled according to its correlation with the received signal before PCR.

The above approaches may improve on previous methods by lowering computational complexity, reducing multicollinearity, and stabilizing coefficient estimation. As a result, the self-interference estimate can be more accurate, cancellation performance can be improved, and full-duplex communication can become more reliable and efficient.

In an embodiment, a method of self-interference cancellation in a full duplex communication system comprises: generating a kernel matrix comprising basis functions representative of self-interference produced by a transmit signal of the full duplex communication system; performing PCR based on the kernel matrix for self-interference estimation; selecting a subset of principal components based on a metric related to a reconstruction error of a received signal; estimating a coefficient vector using the subset of principal components to generate an estimate of the self-interference; and cancelling the self-interference from the received signal based on the self-interference estimate.

In an embodiment, a method of self-interference cancellation in a full duplex communication system comprises: generating a kernel matrix comprising basis functions representative of self-interference produced by a transmit signal of the full duplex communication system; performing PCR on the kernel matrix; selecting a subset of principal components based on a metric computed from eigenvalues, singular vectors, and a correlation between the kernel matrix and a received signal, the metric reflecting an error in estimating a coefficient vector from the subset; estimating the coefficient vector using the subset of principal components to generate an estimate of the self-interference; and cancelling the self-interference from the received signal based on the self-interference estimate.

In an embodiment, a method of self-interference cancellation in a full duplex communication system comprises: generating a kernel matrix comprising basis functions representative of self-interference produced by a transmit signal of the full-duplex communication system; scaling the kernel matrix based on the correlation between basis functions and a received signal; performing PCR on the scaled kernel matrix; selecting a subset of principal components based on eigenvalues of the PCR; estimating the coefficient vector using the subset of principal components to generate an estimate of the self-interference; and cancelling the self-interference from a signal received at a receiver of the full duplex communication system based on the self-interference estimate.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a system for self-interference cancellation in a full-duplex communication system, according to an embodiment;

FIG. 2 is a diagram illustrating components contributing to self-interference in a full-duplex communication system;

FIG. 3 is a flowchart of a method for self-interference cancellation in a full-duplex communication system using PCR with a reconstruction error metric, according to an embodiment;

FIG. 4 is a flowchart of a method for self-interference cancellation in a full-duplex communication system using PCR with a eigenvalue-based error metric, according to an embodiment;

FIG. 5 is a flowchart of a method for self-interference cancellation in a full-duplex communication system using PCR with correlation-based scaling of basis functions, according to an embodiment;

FIG. 6 is a graph illustrating an eigenvalue distribution of an R-matrix, showing all basis functions and a selected subset of basis functions used for self-interference cancellation, according to an embodiment;

FIG. 7 is a block diagram of an electronic device in a network environment, according to an embodiment; and

FIG. 8 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Self-interference cancellation” as used herein refers to techniques for estimating and subtracting interference caused by a transmitter's own signal leaking into its receiver path in a full duplex communication system. Some examples of “self-interference cancellation” are reconstructing the interference using kernel basis functions with coefficients estimated by least squares or recursive least squares, and applying PCR- to improve estimation accuracy.

“Full duplex communication system” as used herein refers to a wireless system in which transmission and reception occur simultaneously over the same frequency band. Some examples of “full duplex communication system” are base stations, mobile handsets, and modem chips configured to support concurrent uplink and downlink communication.

“Kernel matrix” as used herein refers to a matrix whose columns comprise basis functions that model self-interference generated by a transmit signal. Some examples of “kernel matrix” are matrices formed using polynomial basis functions, IQ imbalance terms, or parallel Hammerstein structures that represent different distortion components of the transmit signal.

“Basis functions” as used herein refers to mathematical functions that represent self-interference components generated by a transmit signal in a full duplex communication system. Some examples of “basis functions” are polynomial terms of the transmit signal, memory terms capturing delayed versions of the transmit signal, and combinations thereof. “PCA” as used herein refers to principal component analysis, a statistical technique for transforming correlated basis functions into a set of orthogonal components ranked by their contribution to variance. Some examples of “PCA” are selecting a reduced subset of components based on a reconstruction error of the received signal, or selecting components based on eigenvalue-derived error metrics.

“Principal components” as used herein refers to orthogonal vectors obtained by applying PCA to a kernel matrix, each representing a transformed combination of basis functions ranked by significance. Some examples of “principal components” are components retained for minimizing reconstruction error of the received signal, or components selected based on coefficient error metrics.

PCR is a regression method that uses PCA to reduce the input data to principal components and then performs linear regression on these components.

“Metric related to a reconstruction error of a received signal” as used herein refers to a value that measures how accurately the self-interference estimate reproduces the portion of the received signal attributable to interference. Some examples of “metric related to a reconstruction error of a received signal” are scores computed from eigenvalues and projection coefficients of the kernel matrix, or rankings of principal components based on their contribution to minimizing mean square error between the received signal and the interference estimate.

“Coefficient vector” as used herein refers to a set of estimated weights applied to basis functions of a kernel matrix to generate an estimate of the self-interference. Some examples of “coefficient vector” are vectors estimated using least squares, recursive least squares, or other adaptive algorithms that minimize error.

“Mean square error” as used herein refers to a statistical measure of the average squared difference between an estimated value and the true or observed value. Some examples of “mean square error” are the error between the received signal and the self-interference estimate, or the error between an estimated coefficient vector and a true coefficient vector.

“Eigenvalue decomposition” as used herein refers to a matrix factorization technique that expresses a matrix as the product of three matrices: an eigenvector matrix, a diagonal matrix of eigenvalues, and the conjugate transpose of another eigenvector matrix. Some examples of “eigenvalue decomposition” are decomposing the covariance matrix of a kernel matrix into eigenvalues and eigenvectors, or using eigenvalues to determine the relative importance of principal components.

“Covariance matrix” as used herein refers to a matrix that captures the statistical correlations between basis functions or features in a dataset. Some examples of “covariance matrix” are the matrix R=X^{H}X formed from a kernel matrix, or a covariance matrix used as input to PCA to identify principal components.

“Receiver chain of the full duplex communication system” as used herein refers to the sequence of components that process a received signal after it enters the receiver. Some examples of “receiver chain” are an analog-to-digital converter (ADC), digital baseband processing modules, adaptive filters, and cancellation blocks where an interference estimate is subtracted from the received signal.

“Cumulative threshold of a metric associated with the principal components” as used herein refers to a criterion that selects a subset of principal components by accumulating their metric values until a specified proportion of the total is reached. Some examples of “cumulative threshold of a metric associated with the principal components” are retaining enough principal components to capture 90% of the total eigenvalue energy, or selecting components until the cumulative sum of reconstruction-error metrics exceeds a defined percentage.

“Least squares estimation” as used herein refers to a mathematical technique for estimating coefficients by minimizing the sum of squared differences between observed values and values predicted by a model. Some examples of “least squares estimation” are solving for a coefficient vector that minimizes the error between a received signal and an interference estimate.

“Multicollinearity” as used herein refers to a condition in which two or more basis functions or features are highly correlated, leading to redundancy and instability in coefficient estimation. Some examples of “multicollinearity” are correlation among polynomial basis functions in the kernel matrix, or eigenvectors associated with small eigenvalues that amplify noise in estimation.

“Metric computed from eigenvalues of the PCA that reflects an error in estimating a coefficient vector” as used herein refers to a measure derived from the eigenvalues of the covariance matrix that quantifies how omission or retention of certain principal components affects the accuracy of coefficient estimation. Some examples of “metric computed from eigenvalues of the PCA that reflects an error in estimating a coefficient vector” are bias terms associated with discarded components, noise terms weighted by the inverse of eigenvalues, and combined error scores used to rank and select principal components for self-interference cancellation.

“Eigenvalues” as used herein refers to scalar values that indicate the magnitude of variance captured by corresponding eigenvectors in a matrix decomposition. Some examples of “eigenvalues” are values obtained from EVD of the covariance matrix of a kernel matrix, or eigenvalues used to determine the relative importance of principal components in PCA.

“Scaling” as used herein refers to adjusting the magnitude of basis functions or kernel matrix entries, for example by correlation weighting or variance-based adjustment.

Embodiments of the present disclosure provide methods and systems for self-interference cancellation in full-duplex communication. In certain embodiments, a kernel matrix of basis functions may be generated to represent the self-interference produced by a transmit signal, and PCA may be applied to identify a reduced subset of components that capture the dominant interference characteristics. The subset may be selected using different techniques, including reconstruction error metrics, eigenvalue-based error metrics, or correlation-based scaling of basis functions.

In various embodiments, coefficients are estimated from the selected components and used to generate an interference estimate that is subtracted from a received signal within a receiver chain. By reducing the number of basis functions while maintaining accuracy, the disclosed embodiments provide efficient cancellation with improved numerical stability and lower computational complexity, thereby enabling reliable operation of full-duplex communication systems. The methods described herein may be implemented in hardware, such as modem or baseband processor chips, or in programmable logic, digital signal processors, or general-purpose processors executing software instructions.

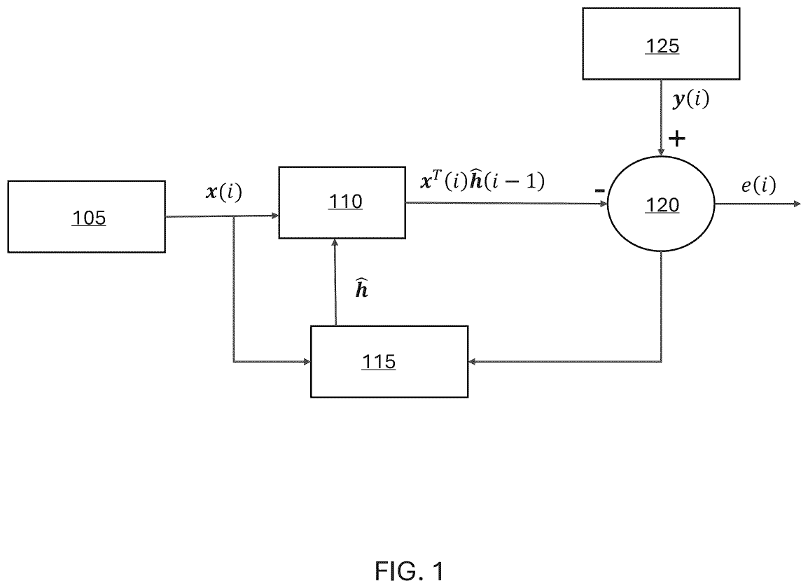

FIG. 1 illustrates an architecture for implementing self-interference cancellation in a full duplex communication system, according to an embodiment. More specifically, FIG. 1 shows functional blocks that cooperate to model, estimate and subtract self-interference generated by a transmit signal so that a desired receive signal can be recovered.

Referring to FIG. 1, at each time instance i, a kernel generator 105 may form an input vector x(i) comprising nonlinear kernel components representative of self-interference produced by the transmit signal. The input vector x(i) may be weighted by a coefficient vector ĥ(i−1) in a transversal filter 110 to generate an output signal ŷ_{ITF}(i)=x^{T}(i)ĥ(i−1), which represents an estimate of the self-interference. The estimate ŷ_{ITF}(i) may be compared with a received signal y(i) obtained at the output of an analog-to-digital converter (ADC) 125. A summer 120 may subtract ŷ_{ITF}(i) from y(i) to generate a residual error signal e(i)=y(i)−ŷ_{ITF}(i). The error signal e(i) may be provided to an adaptive weight control module 115, which may update the coefficient vector ĥ(i) using an adaptation algorithm such as least squares or recursive least squares. The updated coefficient vector may then be fed back to the transversal filter 110, enabling refinement of the interference estimate over time.

In some embodiments, PCA may be applied to the kernel matrix formed by the kernel generator 105 prior to coefficient estimation. PCA may reduce the dimensionality of the basis functions and mitigates multicollinearity, thereby improving numerical stability of the adaptive weight control 115 and lowering computational complexity. The reduced set of principal components may be used in the transversal filter 110 to produce a more accurate estimate of the self-interference while requiring fewer resources. The functional blocks of FIG. 1 may be implemented as dedicated electronic circuits, programmable logic, or as software modules executed by one or more processors.

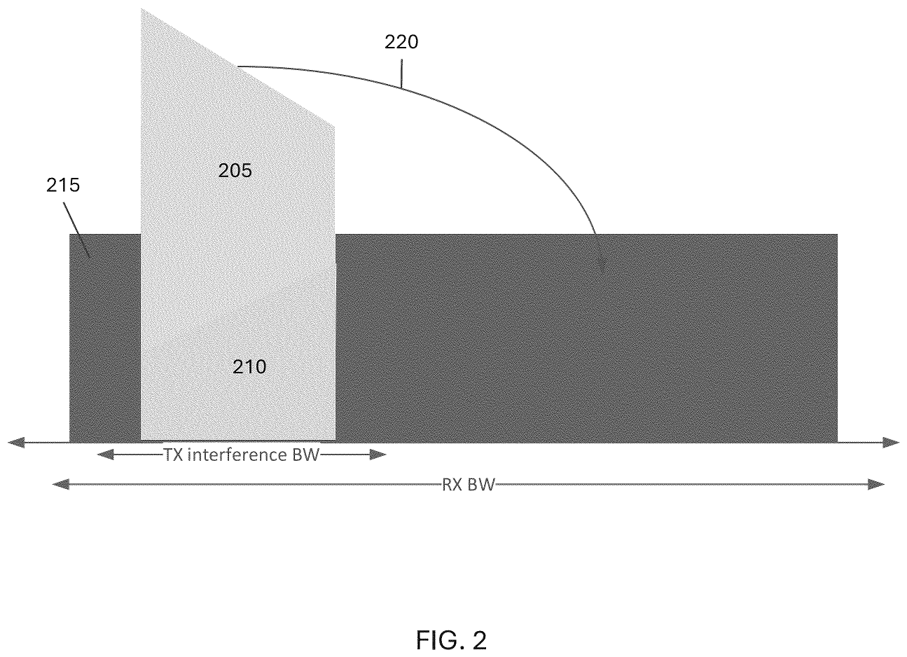

FIG. 2 illustrates example components of self-interference in a full duplex communication system. More specifically, FIG. 2 shows how different distortion mechanisms contribute to the overall interference observed in the receive band.

In the example of FIG. 2, a linear component 205 may represent the direct leakage of the transmit signal into the receive path. An IQ imbalance component 210 may represent distortion arising from a mismatch between in-phase and quadrature signal paths. A nonlinear component 215 may represent higher-order distortions, such as polynomial nonlinearities generated by a power amplifier or mixer imperfections. Arrow 220 may indicate the combined contribution of these components into the receive band along a horizontal frequency axis and a vertical power axis. The notation “Tx interference BW” may denote the transmit interference bandwidth containing the distortion components, while “Rx BW” may denote the receive bandwidth occupied by the desired signal, illustrating how the interference overlaps the receive band.

As illustrated, the self-interference comprises not only a linear leakage but also of IQ imbalance and nonlinear distortion. These components correspond to the nonlinear kernel functions generated in FIG. 1 by the kernel generator 105, which forms the input vector x(i). In various embodiments, the PCA-based selection described herein may operate on kernel functions that capture one or more of the linear, IQ imbalance, and nonlinear contributions depicted in FIG. 2, thereby producing a reduced and more effective basis set for self-interference cancellation.

In some embodiments, the kernel components x(i) used to model self-interference may be generated according to a parallel Hammerstein structure. As illustrated in FIG. 2, the self-interference may include linear leakage, IQ imbalance, and nonlinear distortion, and the kernel generator 105 may form basis functions that capture these effects.

Hereinafter, in modeling the self-interference in a full duplex system, according to an embodiment of the disclosure, the interference estimate at time i may be expressed as shown in Equation (1):

$${\hat{y}}_{ITF} ( i ) = {\sum }_{p = 1 , 3 , …}^{P} {\sum }_{q = 0}^{p} {\sum }_{t = 0}^{T} {\hat{h}}_{p}^{( q , p - q )} ( t ) \times {{x}_{B} ( i - t )}^{q} {{x}_{B}^{*} ( i - t )}^{p - q} \qquad ( 1 )$$

In Equation (1),

$${\hat{h}}_{p}^{( q , p - q )} ( t )$$

may be the estimated coefficients for the basis function of the form x^{q}x*^{p-q}.

The total number of coefficients

$${h}_{p}^{( q , p - q )} ( t )$$

to estimate may be equal to

$$nu {m}_{coeff} = {\sum }_{p = 1 , 3 …}^{P} ( p + 1 ) \times T .$$

This formulation highlights that the number of kernel functions grows rapidly with nonlinearity order and memory depth, leading to high-dimensional modeling of the self-interference.

For clarity of notation, in this disclosure, X may correspond to the kernel matrix, A may be the eigenvectors matrix of the covariance matrix R (i.e. R=X^{H}X) obtained from the EVD decomposition of X^{H}X=AΛA^{H}, ĥ may correspond to the estimate weights coefficients while h may correspond to the true coefficients, and σ² may correspond to the noise power.

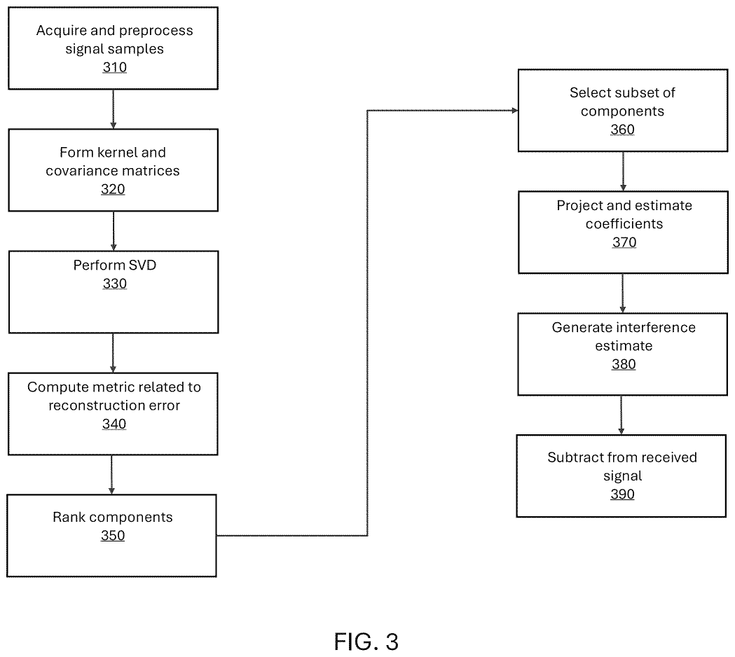

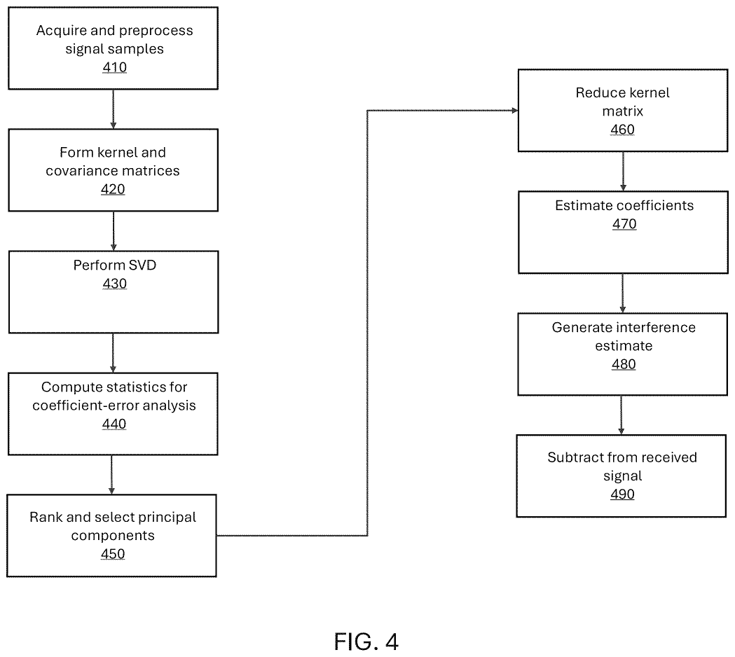

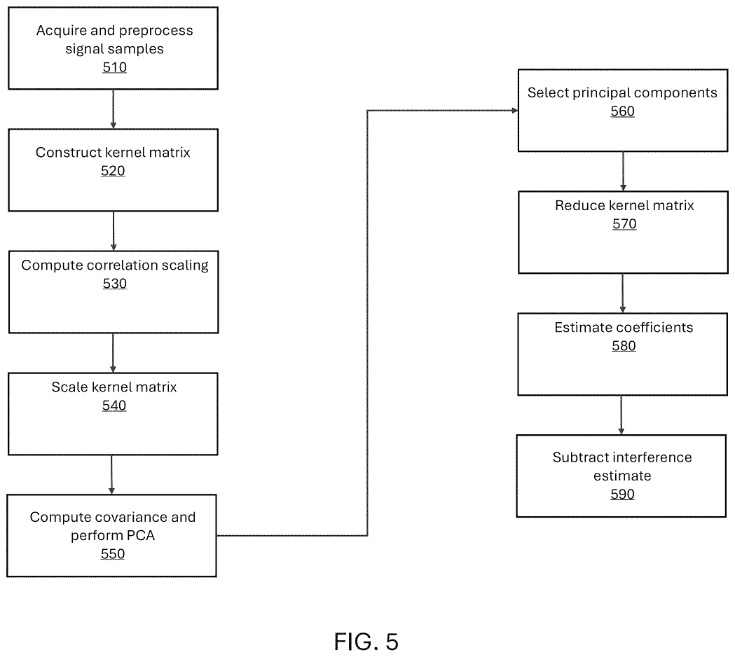

The following flowcharts (FIGS. 3-5) illustrate three alternative embodiments for selecting a subset of basis functions. Each embodiment applies PCR in a different way to emphasize reconstruction accuracy (FIG. 3), coefficient stability (FIG. 4), or correlation with the received signal (FIG. 5).

FIG. 3 is a flowchart of a method for selecting a subset of basis functions for self-interference cancellation in a full duplex communication system, according to an embodiment. The method determines which basis functions most significantly contribute to accurately estimating the self-interference, with the goal of minimizing the mean square error (MSE) between the received signal and the interference estimate. The MSE of the interference estimate ŷ_{ITF}=Xĥ with respect to the received signal y may be expressed as shown in Equation (2):

$$M S E ( {\hat{y}}_{ITF} ) = E [ {‖ y - {\hat{y}}_{ITF} ‖}^{2} ] E [ {‖ y - X \hat{h} ‖}^{2} ] = {\sum }_{k = M + 1}^{P} {λ}_{k} {\vert {α}_{k} \vert}^{2} + {σ}^{2} ( N - M ) \qquad ( 2 )$$

In Equation (2), ĥ may be the estimated coefficient vector, λₖ may denote the k-th eigenvalue of the covariance matrix R=X^{H}X and αₖ may be given by Equation (3):

$${α}_{k} = \frac{{a}_{k}^{H} {X}^{H} X h}{{λ}_{k}} \approx \frac{{a}_{k}^{H} {X}^{H} y}{{λ}_{k}} \qquad ( 3 )$$

In Equation (3),

$${a}_{k}^{H}$$

may represent the Hermitian transpose of the k-th column of matrix A, which contains the eigenvectors of R, n may denote the noise vector, and σ² may be the noise power. The term N may correspond to the total number of samples, while M may denote the number of selected principal components (or basis functions) from the total of P available.

MSE(ŷ_{ITF}) may reflect the squared error between the received signal and the interference estimate, averaged across multiple signal samples. The subsequent steps of the flowchart in FIG. 3 describe how basis functions are selected and coefficients are estimated to minimize this error.

In step 310, at each time index i, transmit signal samples may be obtained from the transmitter path of the full duplex system, and received signal samples may be obtained at the output of the ADC 125. The transmit samples may later be used to generate kernel components that capture nonlinear and memory effects, while the received samples contain both the desired signal and self-interference together with noise. In some embodiments, a set of N transmit and receive samples may be collected for processing. Pre-processing operations such as de-meaning or normalization of the transmit and received signal samples may be performed to facilitate subsequent covariance computation and PCR.

In step 320, the transmit signal samples may be processed by the kernel generator 105 to construct a kernel matrix X whose columns represent nonlinear basis functions modeling self-interference produced by the transmit signal. These basis functions may include polynomial terms, memory terms, or combinations thereof, capturing effects such as amplifier nonlinearities and IQ imbalance. The received signal y may be associated with this kernel matrix such that the interference estimate can be expressed as ŷ_{ITF}=Xĥ, where ĥ may be a coefficient vector to be estimated. From the kernel matrix, a covariance matrix

$$R = \frac{{X}^{H} X}{N}$$

(also denoted as, R=X^{H}X) may be computed, which serves as the basis for subsequent PCA.

In step 330, the covariance matrix R=X^{H}X may be decomposed using eigenvalue decomposition (EVD) or eigen-decomposition to obtain an eigenvector matrix A and a diagonal matrix of eigenvalues Λ. Each eigenvalue λₖ may represent the energy contribution of a corresponding principal component, while the eigenvectors define directions in the transformed feature space. This decomposition enables subsequent ranking and selection of components that most strongly capture the structure of the self-interference while reducing redundancy among correlated basis functions.

In step 340, a metric may be computed for each principal component to quantify its contribution to accurately reconstructing the self-interference. In one approach, an alignment factor αₖ may be determined that measures the correlation between the received signal y and the k-th principal component obtained from the decomposition of the covariance matrix. The metric for the k-th component may then be expressed as given by Equation (4):

Sₖ=λₖ|αₖ|² (4)

In Equation (4), λₖ may be the k-th eigenvalue of the covariance matrix R, and αₖ may represent the normalized projection of the received signal onto the corresponding eigenvector. This metric reflects the reconstruction error that would be introduced if the k-th component were discarded. Components with higher metric values are more strongly aligned with the self-interference structure and therefore carry greater significance for accurate coefficient estimation. By contrast, components with lower metric values contribute little to the reconstruction and may be omitted with minimal impact.

In step 350, the principal components may be ranked according to the selection metric computed in step 340. Specifically, the set of metric values {Sₖ} may be sorted in descending order such that components with the largest values appear first. Ranking in this manner ensures that the basis functions most strongly aligned with the self-interference structure are prioritized. By arranging the components in order of decreasing contribution, the method identifies which basis functions provide the greatest reduction in reconstruction error when retained. This ordering also enables an efficient selection process in subsequent steps, since the number of retained components can be chosen as the first M entries in the sorted list, while the remainder may be discarded with minimal loss of accuracy.

In step 360, a subset of principal components may be selected from the ranked list to form a reduced basis for coefficient estimation. In one embodiment, the first M components with the highest metric values are retained, while the remaining components are discarded. The retained eigenvectors define a transform matrix \tilde{W}, which is applied to the kernel matrix X to produce a reduced kernel matrix X_{final}=X\tilde{W}.

This reduction eliminates redundant or low-contribution basis functions, thereby lowering computational complexity and mitigating numerical instability caused by multicollinearity. The number M of retained components may be determined by a fixed threshold, a cumulative percentage of the total metric values, or other adaptive criteria. By selecting only the most significant components, the method achieves accurate self-interference modeling while reducing resource usage in subsequent coefficient estimation.

In step 370, the kernel matrix X may be projected into the reduced basis formed by the selected principal components, resulting in the reduced kernel matrix X_{final}=X\tilde{W}. Using this reduced matrix, the coefficient vector ĥ may be estimated to model the self-interference. In one embodiment, estimation may be performed using a least squares (LS) algorithm that minimizes the squared error ∥y−X_{final}h∥². In other embodiments, recursive least squares (RLS) or other adaptive estimation algorithms may be used to update ĥ in real time as new signal samples are acquired. By relying on the reduced set of basis functions, the estimation process requires fewer computations, converges more quickly, and provides enhanced numerical stability compared to using the full kernel matrix. The resulting coefficient vector captures the contribution of the selected principal components to the interference structure, preparing the system to generate an interference estimate for cancellation.

In step 380, an interference estimate ŷ_{ITF} may be generated using the reduced kernel matrix and the estimated coefficient vector obtained in step 370. Specifically, the estimate is formed as ŷ_{ITF}=X_{final}ĥ, where X_{final} contains the selected principal components and ĥ represents their corresponding coefficient values. This operation reconstructs the portion of the received signal attributable to self-interference, including distortions arising from linear leakage, IQ imbalance, and nonlinear effects. Because the estimate is based only on the most significant components, it more accurately models the dominant interference contributions while suppressing noise and low-impact terms. The interference estimate is then made available for subtraction from the received signal to improve overall cancellation performance.

In step 390, the interference estimate ŷ_{ITF} generated in step 380 may be subtracted from the received signal y to obtain a residual signal. This subtraction may be carried out in the digital domain within the receiver chain following the ADC 125. The residual signal contains the desired communication signal with significantly reduced distortion from self-interference, as well as additive noise. By removing the dominant interference components, the method improves the effective signal-to-interference-plus-noise ratio (SINR) and enables more reliable demodulation of the desired signal. In certain embodiments, the residual error signal may also be fed back to update the coefficient estimation process, further refining interference-cancellation performance over time.

FIG. 4 is a flowchart of a method for selecting a subset of basis functions for self-interference cancellation in a full duplex communication system, according to an embodiment. In this embodiment, basis functions are chosen by minimizing the MSE of the estimated coefficient vector ĥ that models the self-interference. The MSE of h may be expressed as given by Equation (5):

$$M S E ( h ) = E [ {‖ \hat{h} - h ‖}^{2} ] = \underbrace{{\sum }_{k = M + 1}^{P} {\vert {α}_{k} \vert}^{2}}_{Estimation biais} + \underbrace{{σ}^{2} {\sum }_{k = 1}^{M} \frac{1}{{λ}_{k}}}_{Estimation noise} \qquad ( 5 )$$

In Equation (5), αₖ may represent the projection coefficient for the k-th eigenvector, λₖ may be the k-th eigenvalue of the covariance matrix, and σ² may be the noise power. The first term represents estimation bias introduced by discarding higher-order eigenvectors, while the second term reflects estimation noise from the retained eigenvectors. To balance these effects, a metric Sₖ may be defined as given by Equation (6):

$${𝒮}_{k} = {\vert {\hat{α}}_{k} \vert}^{2} - \frac{{σ}^{2}}{{λ}_{k}} \qquad ( 6 )$$

Basis functions with higher Sₖ values may be ranked as more important for accurate self-interference estimation. The method of FIG. 4 sorts and selects the subset of principal components with the highest scores, thereby reducing multicollinearity and improving stability while minimizing the overall MSE of ĥ.

Similar to step 310 of FIG. 3, in step 410 transmit samples from the transmitter path and received samples from the ADC may be collected. A block of N samples may be used, and simple preprocessing such as de-meaning or normalization can be applied to prepare the data for covariance analysis and PCR.

As in step 320 of FIG. 3, in step 420 the transmit samples may be processed to form a kernel matrix X whose columns represent nonlinear basis functions modeling self-interference. From X, a covariance matrix

$$R = \frac{{X}^{H} X}{N}$$

may be computed. This covariance matrix is then used in later steps to perform PCR and evaluate metrics for selecting the most relevant basis functions.

As in step 330 of FIG. 3, in step 430 an EVD of the covariance matrix R may be performed to obtain eigenvalues and eigenvectors, which are then used to compute the coefficient-error metric in the next step.

In step 440, a metric may be computed to evaluate the relative importance of each basis function with respect to minimizing the MSE of the coefficient vector ĥ. The MSE of the coefficient vector may be expressed as given by Equation (5). In Equation (5), The variables αₖ, λₖ, and σ² may be as defined above. The first term of Equation (5) represents estimation bias introduced by discarding higher-order eigenvectors, while the second term reflects estimation noise from the retained eigenvectors.

To balance these effects, a metric (or score) Sₖ may be calculated for each basis function as given by Equation (6). This score reflects the degree to which the k-th basis function contributes useful signal information while accounting for noise sensitivity. Basis functions with larger Sₖ values may be considered more relevant for accurate coefficient estimation. The set of principal components may be ranked in descending order of Sₖ to guide selection in the subsequent step.

Unlike step 340 of FIG. 3, which minimizes the reconstruction error of the received signal, step 440 focuses on minimizing error in the coefficient vector itself, thereby addressing both bias and noise in parameter estimation.

In step 450, the basis functions may be ranked according to their corresponding scores Sₖ computed in step 440. The ranking may be performed in descending order such that basis functions with higher scores, which indicate stronger contributions to accurate coefficient estimation, are prioritized. A subset of M principal components may then be selected from the total set of P available components by retaining those with the largest scores. The selected subset forms a reduced transform matrix that is subsequently applied to the kernel matrix to obtain a reduced representation used in coefficient estimation. Discarding lower-ranked components in this way reduces computational complexity and mitigates noise amplification associated with weak eigenvalues.

In 460, the kernel matrix X may be projected onto the reduced transform matrix formed by the M selected principal components from step 450. This operation produces a reduced kernel matrix, denoted X_{final}, which contains only the most significant components for self-interference estimation. By discarding less relevant basis functions, the reduced matrix lowers computational complexity while preserving the dominant features required for accurate coefficient estimation.

In step 470, similar to step 370 of FIG. 3, the reduced kernel matrix X_{final} may be used to estimate the coefficient vector ĥ. Estimation may be performed using algorithms such as least squares or recursive least squares, providing weights that model the self-interference.

In step 480, corresponding to step 380 of FIG. 3, the estimated coefficient vector may be applied to the reduced kernel matrix to generate an estimate of the self-interference signal.

In step 490, similar to step 390 of FIG. 3, the self-interference estimate may be subtracted from the received signal within the receiver chain. This subtraction yields a residual signal in which the desired receive signal is more accurately recovered with reduced distortion.

In contrast to FIG. 3, which emphasizes reconstruction accuracy of the received signal, FIG. 4 provides an embodiment that directly minimizes the error of the coefficient vector. This embodiment achieves improved stability in coefficient estimation, particularly in the presence of noise or multicollinearity.

FIG. 5 is a flowchart of a method for selecting a subset of basis functions for self-interference cancellation in a full duplex communication system, according to an embodiment. In this embodiment, PCA may be applied to a kernel matrix whose basis functions are scaled according to their correlation with the received signal. By weighting the kernel functions in proportion to their alignment with the received signal prior to performing PCR, this method finds components most relevant to interference estimation. The correlation-based scaling improves the robustness of principal component selection and reduces the impact of irrelevant or weakly correlated basis functions.

In step 510, transmit signal samples may be obtained from the transmitter path and received signal samples may be obtained at the output of an ADC, in a manner similar to steps 310 of FIG. 3 and 410 of FIG. 4. A block of N samples may be collected for processing. In certain embodiments, preprocessing such as de-meaning or normalization of the samples may be performed to facilitate construction of the kernel matrix and subsequent principal component analysis.

In step 520, similar to steps 320 of FIG. 3 and 420 of FIG. 4, the transmit signal samples may be processed to construct a kernel matrix X whose columns represent nonlinear basis functions modeling self-interference produced by the transmit signal. These basis functions may include polynomial terms, memory terms, or combinations thereof. The kernel matrix may serve as the foundation for correlation-based scaling in the subsequent step.

In step 530, correlation values may be determined between each basis function of the kernel matrix X and the received signal y. These correlation values may indicate the relative alignment of each basis function with the received signal, reflecting how strongly each basis function contributes to modeling the self-interference. Based on the computed correlation values, scaling weights may be assigned to the columns of the kernel matrix. Basis functions with stronger correlation may be emphasized, while those with weaker correlation may be downweighted (or deemphasized). The scaling weights may be subsequently applied to form a weighted kernel matrix, as described in step 540.

In step 540, the kernel matrix X may be rescaled using the correlation-based weights determined in step 530. Each column of X, representing a basis function, may be multiplied by its corresponding weight so that the resulting weighted kernel matrix emphasizes basis functions more strongly correlated with the received signal. The scaled kernel matrix, denoted X_{scaled}, may then be used in subsequent covariance analysis and principal component selection. By reweighting the basis functions in proportion to their correlation, the method directs the PCR process to focus on components most relevant for accurate self-interference estimation.

In step 550, a covariance matrix may be computed from the scaled kernel matrix X_{scaled}. PCA may then performed on the covariance matrix, for example by applying EVD to obtain eigenvalues and eigenvectors. The eigenvalues indicate the relative significance of the corresponding eigenvectors, while the eigenvectors represent orthogonalized versions of the weighted basis functions. Because the kernel matrix was scaled in steps 530 and 540, the PCR process emphasizes basis functions that are not only orthogonal but also strongly correlated with the received signal.

In step 560, the principal components obtained from the PCA of the scaled kernel matrix may be ranked and a subset may be selected. Because the kernel matrix was weighted according to correlation with the received signal, the PCA process prioritizes basis functions that are orthogonalized and strongly correlated with the signal of interest. A subset of M principal components may be retained from the total P available, with those having the largest eigenvalues after scaling being selected. The selected components form a reduced transform matrix that is applied to the kernel matrix in the next step. Unlike FIG. 3, which is based on reconstruction error, and FIG. 4, which is based on coefficient error, FIG. 5 derives its component selection from correlation alignment with the received signal, thereby improving robustness in identifying the most relevant basis functions.

In 570, the kernel matrix X_{scaled} may be projected onto the subset of M principal components selected in step 560. This projection produces a reduced kernel matrix, denoted X_{final}, which contains only the most significant basis functions emphasized by the correlation-based scaling and PCR. By discarding less relevant or weakly correlated components, the reduced kernel matrix lowers computational complexity while preserving the dominant features necessary for accurate coefficient estimation in subsequent steps.

In step 580, similar to steps 370 of FIG. 3 and 470 of FIG. 4, the reduced kernel matrix X_{final} and the received signal ŷ may be used to estimate the coefficient vector h that models the self-interference. In one embodiment, estimation may be performed using least squares to minimize the error between y and the reconstruction based on X_{final}; in other embodiments, recursive least squares or another adaptive estimator is used to update h as new samples are acquired. Using the correlation-emphasized X_{final} improves numerical stability and focuses the estimation on basis functions most relevant to the received signal.

In step 590, similar to steps 390 of FIG. 3 and 490 of FIG. 4, the estimated coefficient vector ĥ may be applied to the reduced kernel matrix X_{final} to generate an estimate of the self-interference signal. This estimate may then be subtracted from the received signal within the receiver chain, yielding a residual signal in which the desired receive signal is more accurately recovered with reduced distortion.

The flowchart of FIG. 5 but differs from those of FIGS. 3 and 4 by applying correlation-based scaling to the kernel matrix before PCA. This emphasizes basis functions most aligned with the received signal, making the selection of principal components more robust and reducing the impact of weak or irrelevant functions. The method thus complements the reconstruction-error embodiment of FIG. 3 and the coefficient-error embodiment of FIG. 4.

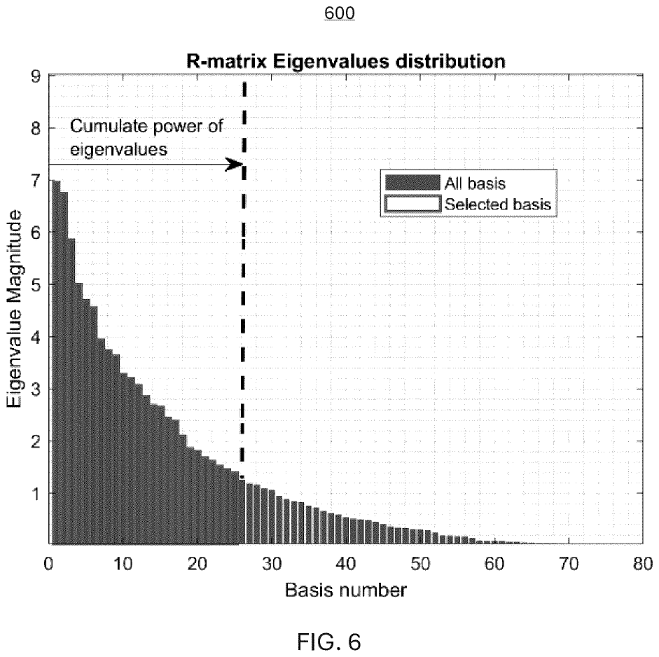

FIG. 6 illustrates 600, which is an example distribution of eigenvalues of the covariance matrix R used in the PCA-based basis selection process. The horizontal axis may represent the basis number, corresponding to the ordering of eigenvectors obtained from EVD of the kernel matrix. The vertical axis may represent the magnitude of the eigenvalues associated with each basis function. Larger eigenvalues may indicate components that capture more of the variance and thus contribute more significantly to modeling self-interference.

In the example shown, the set of all available basis functions is represented in one format (e.g., shading), while the subset of principal components selected according to the methods described above is shown in another format. A cumulative power threshold, indicated by a dividing line, separates the retained basis functions from those discarded. Retaining only the subset of basis functions associated with the largest eigenvalues allows the dimensionality of the kernel matrix to be reduced while preserving the dominant features of the self-interference.

The distribution of eigenvalues shown in FIG. 6 demonstrates how PCA concentrates most of the signal energy in a smaller number of basis functions. By selecting the subset of basis functions above the threshold, the system improves computational efficiency and stability while maintaining accurate interference cancellation performance. As such, FIG. 6 illustrates the effect of the basis selection steps described in FIG. 3 (reconstruction-error based), FIG. 4 (coefficient-error based), and FIG. 5 (correlation-based scaling), each of which may use eigenvalue magnitudes to determine which components are retained.

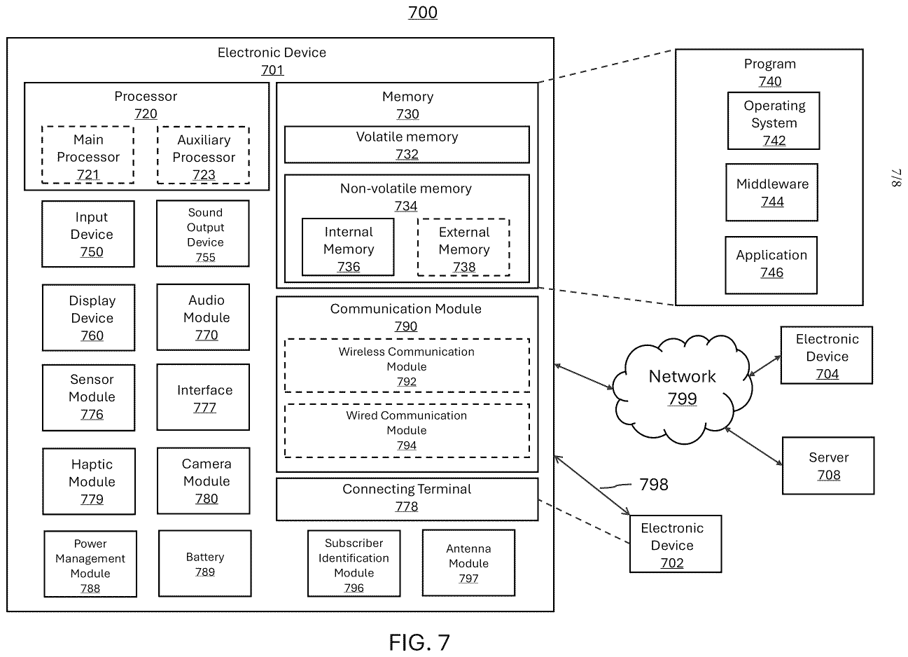

FIG. 7 is a block diagram of an electronic device in a network environment 700, according to an embodiment.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

In certain embodiments, the self-interference cancellation methods disclosed herein may be performed on one or more of the components of the electronic device 701 of FIG. 7. For example, the processor 720, which may include the main processor 721 or the auxiliary processor 723, may execute instructions for generating a kernel matrix, performing PCA, and estimating coefficients for self-interference cancellation. Alternatively or additionally, the communication module 790, which includes processing elements related to transceiver operations, may implement at least part of the interference cancellation process in hardware or firmware. In some embodiments, the adaptive filtering and PCA operations may be distributed between the processor 720 and the communication module 790 to balance computational load. Thus, the disclosed methods may be carried out within the receiver chain of the communication module 790, by the processor 720, or by a combination of these components.

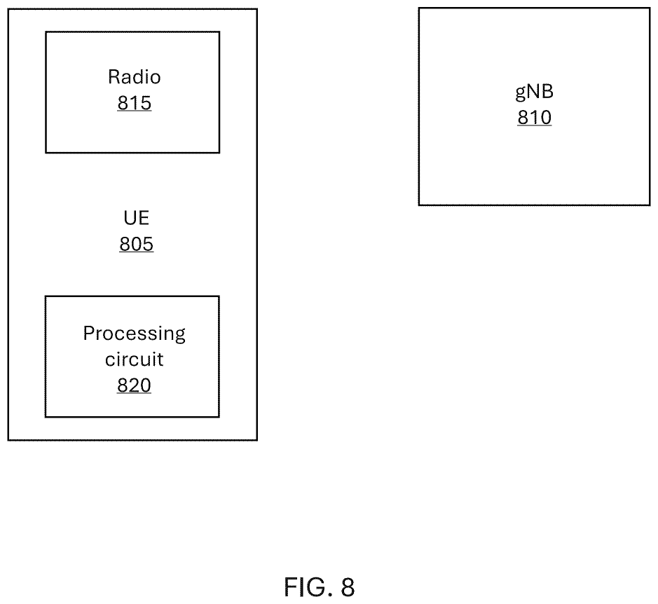

FIG. 8 shows a system including a UE 805 and a gNB 810, in communication with each other. The UE may include a radio 815 and a processing circuit (or a means for processing) 820, which may perform various methods disclosed herein, e.g., the method illustrated in FIG. 1. For example, the processing circuit 820 may receive, via the radio 815, transmissions from the network node (gNB) 810, and the processing circuit 820 may transmit, via the radio 815, signals to the gNB 810.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of self-interference cancellation in a full duplex communication system, the method comprising:
generating a kernel matrix comprising basis functions representative of self-interference produced by a transmit signal of the full duplex communication system;
performing principal component regression (PCR) based on the kernel matrix for self-interference estimation;
selecting a subset of principal components based on a metric related to a reconstruction error of a received signal;
estimating a coefficient vector using the subset of principal components to generate an estimate of the self-interference; and
cancelling the self-interference from the received signal based on the self-interference estimate.

2. The method of claim 1, wherein the metric is based on a mean square error between the received signal and the self-interference estimate.

3. The method of claim 1, further comprising performing a eigenvalue decomposition of a covariance matrix of the kernel matrix.

4. The method of claim 1, wherein selecting comprises ranking the principal components according to the metric and retaining principal components having highest metric values.

5. The method of claim 1, wherein the estimate of the self-interference is subtracted from the received signal within a receiver chain of the full duplex communication system.

6. The method of claim 1, further comprising determining a number of principal components to retain based on a cumulative threshold of a metric associated with the principal components.

7. The method of claim 1, wherein estimating the coefficient vector comprises applying at least one of least squares estimation or recursive least squares estimation.

8. The method of claim 1, performing the PCR reduces multicollinearity among the basis functions by transforming the kernel matrix into a set of orthogonal principal components and discarding components associated with lower metric values.

9. A method of self-interference cancellation in a full duplex communication system, the method comprising:
generating a kernel matrix comprising basis functions representative of self-interference produced by a transmit signal of the full duplex communication system;
performing principal component regression (PCR) on the kernel matrix;
selecting a subset of principal components based on a metric computed from eigenvalues, singular vectors, and a correlation between the kernel matrix and a received signal, the metric reflecting an error in estimating a coefficient vector from the subset;
estimating the coefficient vector using the subset of principal components to generate an estimate of the self-interference; and
cancelling the self-interference from the received signal based on the self-interference estimate.

10. The method of claim 9, wherein the metric accounts for an error contributed by discarded principal components and an error contributed by retained principal components.

11. The method of claim 9, wherein selecting comprises discarding principal components based on the metric.

12. The method of claim 9, wherein estimating the coefficient vector comprises applying at least one of least squares estimation or recursive least squares estimation.

13. The method of claim 9, further comprising determining a number of principal components to retain based on a cumulative threshold of the metric.

14. The method of claim 9, wherein performing the PCR reduces multicollinearity among the basis functions by transforming the kernel matrix into a set of orthogonal principal components and discarding components associated with lower metric values.

15. The method of claim 9, wherein the estimate of the self-interference is subtracted from a received signal within a receiver chain of the full duplex communication system.

16. A method of self-interference cancellation in a full duplex communication system, the method comprising:
generating a kernel matrix comprising basis functions representative of self-interference produced by a transmit signal of the full-duplex communication system;
scaling the kernel matrix based on the correlation between basis functions and a received signal;
performing principal component regression (PCR) on the scaled kernel matrix;
selecting a subset of principal components based on eigenvalues of the PCR;
estimating the coefficient vector using the subset of principal components to generate an estimate of the self-interference; and
cancelling the self-interference from a signal received at a receiver of the full duplex communication system based on the self-interference estimate.

17. The method of claim 16, wherein scaling the kernel matrix comprises weighting each basis function in proportion to its correlation with the received signal.

18. The method of claim 16, wherein selecting comprises ranking the principal components according to eigenvalues and retaining principal components having highest eigenvalues.

19. The method of claim 16, wherein estimating the coefficient vector comprises applying at least one of least squares estimation or recursive least squares estimation.

20. The method of claim 16, wherein the estimate of the self-interference is subtracted from the received signal within a receiver chain of the full duplex communication system.
